(19) United States
(12) Patent Application Publication
(10) Pub. No.: US 2024/0041562 A1
(43) Pub. Date: Feb. 8, 2024

(54) DENTAL FILE

(71) Applicant: MANI, Inc., Tochigi (JP)

(72) Inventors: Kazuhiko MATSUTANI, Tochigi (JP); Masamitsu OGINO, Tochigi (JP); Masahiro TOYODA, Tochigi (JP); Yuto YOSHIZAWA, Tochigi (JP); Hiroaki KOBAYASHI, Tochigi (JP); Atsuya YAGI, Tochigi (JP)

(21) Appl. No.: 17/766,666

(22) PCT Filed: Sep. 29, 2020
(86) PCT No.: PCT/JP2020/036923

§ 371 Date: Apr. 5, 2022

(30) Foreign Application Priority Data
Oct. 11, 2019 (JP) 2019-188038
Oct. 11, 2019 (JP) 2019-188041

(51) Int. Cl. A61C 5/42

(52) U.S. Cl. CPC A61C 5/42

(57) ABSTRACT

[Problem] To increase the flexibility, cutting ability, and/or fracture resistance of a dental file.

[Solution] A cross-sectional shape of a dental file 100 includes an arc-shaped portion 111, and first to third linear portions 112 to 114 that are continuous sequentially from the arc-shaped portion 111. The diameter of a virtual circle 101 including the arc-shaped portion 111 is configured to decrease from a proximal end portion toward a distal end portion. A connection point 122 between the first and second linear portions 112 and 113, and a connection point 123 between the second and third linear portions 113 and 114 are located inside the virtual circle 101. An angle A11 that a diameter passing through a connection point 121 forms with the first linear portion 112 is set in such a manner as to increase from the proximal end portion toward the distal end portion.

### TECHNICAL FIELD

The present invention relates to a dental file that is used to shape and clean the root canal in dental treatment.

### BACKGROUND ART

Reamers and files are used as dental root canal cutting instruments that are used to shape and clean the root canal in dental treatment (refer to, for example, Patent Literature 1). The reamer is used to cut the inside of the root canal mainly by being rotated. The file is used to cut the inside of the root canal by, for example, being rotated, and pushed and pulled in the axial direction.

General dental files include those used while holding a gripping portion by hand, and those used by connecting a gripping portion to a dental handpiece. The dental file includes a helical working portion that is tapered toward the distal end, a shaft that is continuous to a rear end of the working portion, and a gripping portion that is continuous to a rear end of the shaft.

The main performance required for such a dental file includes flexibility that allows following the complicated shape of the root canal, cutting ability that allows cutting the root canal appropriately, and fracture resistance that resists breakage during work. As these abilities increase, the root canal can be prepared more easily and more rapidly. As a result, burdens on practitioners and patients can be reduced.

### CITATION LIST

### Patent Literature

PATENT LITERATURE 1: JP-A-2005-278945

### SUMMARY OF INVENTION

### Problems to be Solved by Invention

Considering the above circumstances, an object of the present invention is to increase the flexibility, cutting ability, and/or fracture resistance of a dental file.

### Solutions to Problems

In order to achieve the above object, according to a feature of the present invention, there is provided a dental file including a working portion formed in a helix shape, wherein a shape of a cross section perpendicular to a longitudinal direction includes one arc-shaped portion, and three first to third linear portions that are continuous sequentially from the arc-shaped portion; a diameter of a virtual circle including the arc-shaped portion is set in such a manner as to decrease from a proximal end portion toward a distal end portion; a connection point between the first and second linear portions, and a connection point between the second and third linear portions are set in such a manner as to be located inside the virtual circle; and an angle that a diameter passing through a connection point between the arc-shaped portion and the first linear portion forms with the first linear portion is set in such a manner as to increase from the proximal end portion toward the distal end portion.

Consequently, if the dental file rotates, for example, in a direction from the arc-shaped portion to the first linear portion, mainly the connection point between the arc-shaped portion and the first linear portion performs cutting while the arc-shaped portion moves along the inner surface of a cut hole, and the angle that the diameter passing through the connection point between the arc-shaped portion and the first linear portion forms with the first linear portion is set in such a manner as to increase from the proximal end portion toward the distal end portion. Therefore, for example, it is possible to improve cutting performance, extraction performance, and flexibility up to the proximal end portion while reducing a cutting force near the distal end.

Moreover, in order to achieve the above object, according to a feature of the present invention, there is provided a dental file including a working portion formed in a helix shape, wherein a shape of a cross section perpendicular to a longitudinal direction includes one arc-shaped portion, and three first to third linear portions that are continuous sequentially from the arc-shaped portion; a diameter of a virtual circle including the arc-shaped portion is set in such a manner as to decrease from a proximal end portion toward a distal end portion; a connection point between the first and second linear portions is set in such a manner as to be located on the virtual circle; and a connection point between the second and third linear portions is set in such a manner as to be located inside the virtual circle.

Consequently, if the dental file rotates, for example, in a direction from the arc-shaped portion to the first linear portion, in addition to the connection point between the arc-shaped portion and the first linear portion, the connection point between the first and second linear portions performs cutting. Therefore, high cutting ability can be easily maintained. On the other hand, the connection point between the first and second linear portions is not diagonal to the connection point between the arc-shaped portion and the first linear portion, which reduces the risk of occurrence of, for example, a sudden stop of rotation due to bite during cutting. As a result, it can be easily configured in such a manner as to resist fracture due to impact.

### Effects of Invention

According to the present invention, it is possible to increase the flexibility, cutting ability, and/or fracture resistance of a dental file.

### BRIEF DESCRIPTION OF DRAWINGS

FIG. 1 is a plan view of a dental file according to a first embodiment.

FIG. 2 is a cross-sectional view along line II-II in FIG. 1.

FIG. 3 is a cross-sectional view along line III-III in FIG. 1.

FIG. 4 is a diagram corresponding to the cross section along line III-III in FIG. 1, in a second embodiment.

FIG. 5 is a cross-sectional view along line II-II in FIG. 1, in a third embodiment.

FIG. 6 is a cross-sectional view along line III-Ill in FIG. 1, in the third embodiment.

### DESCRIPTION OF EMBODIMENTS

Embodiments of the present invention are described in detail hereinafter with reference to the drawings. In the following embodiments and modifications, the same reference signs are assigned to constituent elements having similar functions, and descriptions thereof are omitted.

### First Embodiment

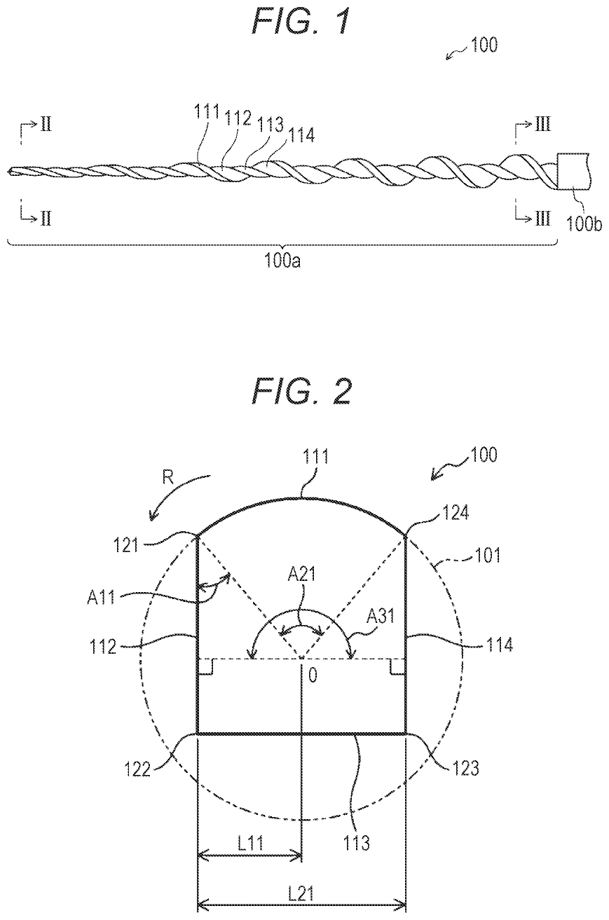

As illustrated in FIG. 1, a dental file 100 includes a working portion 100a that cuts the root canal, a shaft 100b that is continuous to a rear end of the working portion 100a, and an unillustrated gripping portion that is continuous to a rear end of the shaft 100b and attached to a dental handpiece. For example, highly elastic nickel titanium that is suitable for treatment of the complicatedly curved root canal is frequently used as the material of the dental file 100, but the material is not limited to nickel titanium. For example, stainless materials, various alloys, and plastics can also be applied.

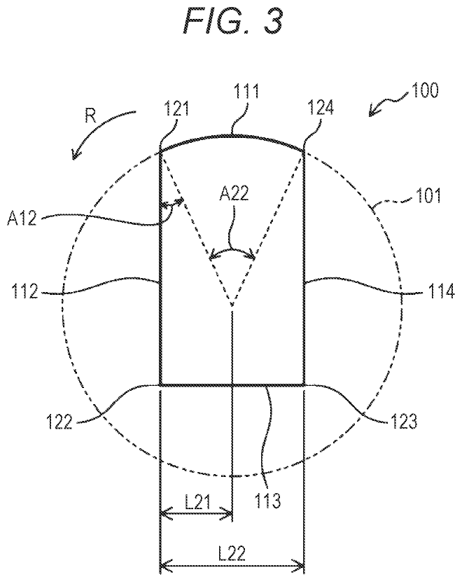

The working portion 100a of the dental file 100 has a configuration where an envelope surface of an outer surface has a tapered shape of which cross section is reduced in size toward the distal end, and cross sections of a similar shape form a helix. More specifically, the shape of a cross section, which is perpendicular to a longitudinal direction, of the working portion 100a is formed as illustrated in, for example, FIG. 2 or 3 of a cross-sectional view along line II-II or line III-III in FIG. 1.

In other words, the above cross-sectional shape includes one arc-shaped portion 111 (a land portion), and three first to third linear portions 112 to 114 that are continuous sequentially from the arc-shaped portion 111. It is set in such a manner that the diameter of a virtual circle 101 that includes the arc-shaped portion 111 and is centered on O is reduced from the proximal end portion toward the distal end portion of the working portion 100a.

The linear portions 112 to 114 are neither necessarily nor strictly straight lines. Even if the linear portions 112 to 114 are, for example, curved to some extent, effects described below can still be obtained. For convenience's sake, FIGS. 2 and 3 are drawn on a scale where diameters of the virtual circle 101 are equal.

A connection point 122 between the first linear portion 112 and the second linear portion 113, and a connection point 123 between the second linear portion 113 and the third linear portion 114 are set in such a manner as to be located inside the virtual circle 101. Moreover, although not particularly limited, for example, the first linear portion 112 and the third linear portion 114 are formed parallel to each other, which allows facilitating a blade groove grinding process, and easily increasing the accuracy of the blade groove grinding process.

Assume that the rotation direction in which debris on the working portion 100a is delivered toward the proximal end during normal use of the dental file 100 is a main rotation direction R. In other words, specifically, if the helix of the dental file 100 is, for example, right handed, assume that a counterclockwise direction is the main rotation direction R as viewed from the distal end. When a rotation is performed in such a direction R, a connection point 121 between the arc-shaped portion 111 and the first linear portion 112 performs a cutting action with the rotation of the dental file 100. The rotation direction of the dental file 100 is not limited to the direction R, and, for example, a mode including a reverse rotation, or a mode that changes the rotation directions alternately may be used.

Moreover, angles A11 and A12 that a diameter of the virtual circle 101 passing through the connection point 121 between the arc-shaped portion 111 and the first linear portion 112 forms with the first linear portion 112 are set in such a manner that the angle at the distal end portion (for example, A11) is larger than the angle at the proximal end portion (for example, A12). The absolute magnitudes of the angles A11 and A12 are not particularly limited, but are set within a range of, for example, 10° to 40°.

The above angles A11 and A12 can be set by, for example, setting a distance from the center O of the virtual circle 101 to the first linear portion 112 relative to the diameter of the virtual circle 101 (the ratio of the distance) in such a manner that a distance L11 at the distal end portion is longer than a distance L21 at the proximal end portion.

Moreover, in fact, the settings can also be made by specifying the ratios of the distance L21 and a distance L22 between the first linear portion 112 and the third linear portion 114 to the diameter of the virtual circle 101 although not equivalent to the above settings. In other words, for example, especially if the cross-sectional shape of the dental file 100 is symmetric about a straight line passing through the center O of the virtual circle 101, and the first linear portion 112 and the third linear portion 114 are formed parallel, the ratios of the distances L21 and L22 between the first linear portion 112 and the third linear portion 114 to the diameter of the virtual circle 101 may be set in such a manner as to increase from the proximal end portion toward the distal end portion of the dental file 100. Moreover, central angles A21 and A22 of the arc-shaped portion 111 may be set in such a manner as to increase from the proximal end portion toward the distal end portion of the dental file 100.

Consequently, it is easy to exert effects at a stage where it is desired to slightly reduce the cutting force near the distal end (such as an early stage of root canal preparation), and in improvement in followability, for example, in a root canal that is curved near the root apex. Moreover, the cutting performance and the extraction performance improve up to a shank portion, and the flexibility also improves up to the shank portion. As a result, compatibility between the cutting ability and the operability can also be encouraged. Furthermore, a portion around the distal end is what is called “resilient”, which also facilitates improving rotation transmission ability.

### Second Embodiment

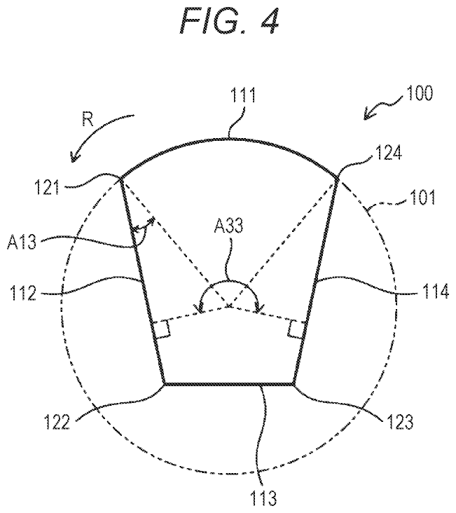

An angular relationship similar to the above angles A11 and A12 at the distal end portion and at the proximal end portion of the dental file 100 can also be set by forming the shape of a cross section at the proximal end portion as illustrated in FIG. 4.

In other words, an angle that a perpendicular from the center O of the arc-shaped portion 111 to the first linear portion 112 forms with a perpendicular from the center O to the third linear portion 114 (an angle subtended on the arc-shaped portion 111 side) is set in such a manner that an angle A31 at the distal end portion is smaller than an angle A33 at the proximal end portion. Consequently, the angles A11 and A13 that a diameter of the virtual circle 101 passing through a connection point 121 between the arc-shaped portion 111 and the first linear portion 112 forms with the first linear portion 112 can be set in such a manner that the angle at the distal end portion (for example, A11) is larger than the angle at the proximal end portion (for example, A13).

Consequently, again, not only can the cutting performance be obtained at an appropriate level at a stage where it is desired to slightly reduce the cutting force near the distal end (such as an early stage of root canal preparation) but also it becomes easy to exert an effect at a finishing stage and in cases where the cutting force is required along the entire length. Moreover, it is possible to increase the cutting force toward a shank portion while having the high ability to follow the shape of a curved root canal. Moreover, the cutting performance and the extraction performance improve up to the shank portion, and the flexibility also improves up to the shank portion. As a result, compatibility between the cutting ability and the operability can also be encouraged.

### Third Embodiment

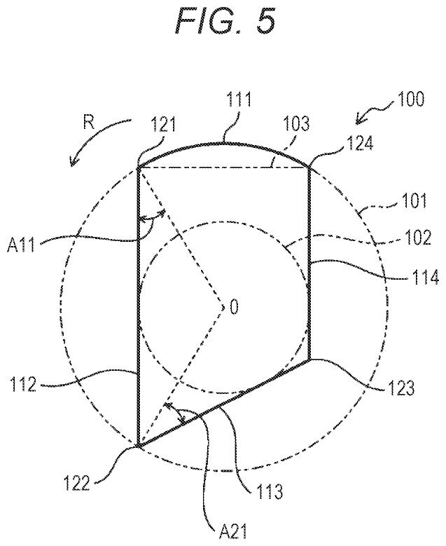

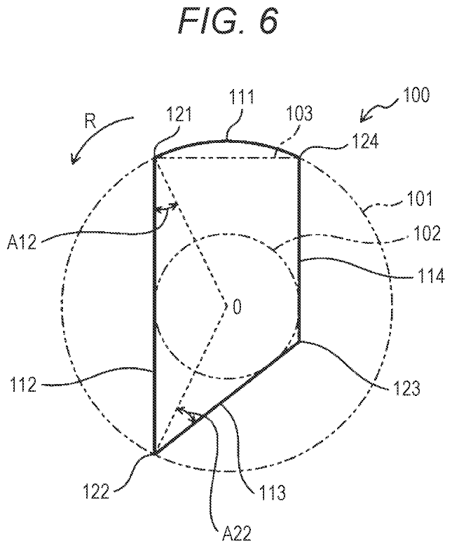

A cross-sectional shape according to a third embodiment is formed as illustrated in, for example, FIG. 5 or 6 of a cross-sectional view along line II-II or line III-III in FIG. 1. In other words, the above cross-sectional shape includes one arc-shaped portion 111 (a land portion), and three first to third linear portions 112 to 114 that are continuous sequentially from the arc-shaped portion 111. It is set in such a manner that the diameter of a virtual circle 101 that includes the arc-shaped portion 111 and is centered on O is reduced from the proximal end portion toward the distal end portion of the working portion 100a. The linear portions 112 to 114 are neither necessarily nor strictly straight lines. Even if the linear portions 112 to 114 are, for example, curved to some extent, effects described below can still be obtained. For convenience's sake, FIGS. 5 and 6 are drawn on a scale where diameters of the virtual circle 101 are equal.

A connection point 122 between the first linear portion 112 and the second linear portion 113 is set in such a manner as to be located on the virtual circle 101. Furthermore, a connection point 123 between the second linear portion 113 and the third linear portion 114 is set in such a manner as to be located inside the virtual circle 101. Moreover, although not particularly limited, for example, the first linear portion 112 and the third linear portion 114 are formed perpendicular to a chord 103 of the arc-shaped portion 111 and parallel to each other, which allows facilitating a blade groove grinding process, and easily increasing the accuracy of the blade groove grinding process.

Assume that the rotation direction in which debris on the working portion 100a is delivered toward the proximal end during normal use of the dental file 100 is a main rotation direction R. In other words, specifically, if the helix of the dental file 100 is, for example, right handed, assume that a counterclockwise direction is the main rotation direction R as viewed from the distal end. Two connection points 121 and 122 that are located on the virtual circle 101 as described above are provided and perform cutting when a rotation is performed in such a direction R. As a result, high cutting ability can be easily maintained.

On the other hand, the connection point 122 is located at a position that is offset from a diameter passing through the connection point 121, and the connection point 123 that is diagonal to the connection point 121 is inside the virtual circle 101, which reduces the risk of occurrence of, for example, a sudden stop of rotation (lock) due to bite during cutting. Therefore, it can also be configured to resist fracture due to impact resulting from lock. The rotation direction of the dental file 100 is not limited to the direction R, and a mode including a reverse rotation, or a mode where the rotation directions change alternately may be used.

Moreover, the connection point 123 between the second linear portion 113 and the third linear portion 114 is provided as described above. Consequently, it is possible to easily set the length of the arc-shaped portion 111 not too long due to the third linear portion 114 while setting angles A21 and A22 that a diameter passing through the connection point 122 between the first linear portion 112 and the second linear portion 113 forms with the second linear portion 113 large to some extent. Hence, the arc-shaped portion 111 is set not too long while the angles A21 and A22 are set large to some extent to resist impact fracture due to a screw-in effect or lock. As a result, the occurrence of fatigue fracture can be easily reduced by, for example, increasing the followability and the flexibility.

Moreover, the connection point 121 between the arc-shaped portion 111 and the first linear portion 112 is set in such a manner as to be located upstream of the connection point 122 between the first linear portion 112 and the second linear portion 113 in the main rotation direction R of the dental file. Moreover, in a case of the above relationship between the cross-sectional shape and the main rotation direction, the arc-shaped portion 111, and the first to third linear portions 112 to 114 are formed in such a manner as to appear sequentially on a side portion of the working portion 100a from the distal end portion to the proximal end portion of the dental file 100. In a case of such a relationship between the cross-sectional shape and the rotation direction, cutting is performed by the connection point 121 at a downstream end of the arc-shaped portion 111 in the main rotation direction R first, and then by the connection point 122 located on the virtual circle 101 with the rotation of the dental file 100. As a result, high cutting ability can be easily maintained.

Moreover, although not particularly limited, for example, angles A11 and A12 that the diameter of the virtual circle 101 passing through the connection point 121 between the arc-shaped portion 111 and the first linear portion 112 forms with the first linear portion 112 are set equal to angels A21 and A22 that the diameter of the virtual circle 101 passing through the connection point 122 between the first linear portion 112 and the second linear portion 113 forms with the second linear portion 113. More specifically, the angles are set to, for example, equal to or greater than 10° and equal to or less than 40°, preferably, for example, approximately 30°. The cutting ability can be easily set at an appropriate level within such an angle range under normal circumstances.

It is also possible to specify the dimension of each portion instead of the above settings of angles. In other words, for example, the distances from the center O of the virtual circle 101 to the first to third linear portions 112 to 114 may be set equal to each other. Alternatively, the linear portions 112 to 114 may be designed to touch the same inscribed circle 102. Such a shape can be easily formed by equalizing the amounts of cut from the circumference of the virtual circle 101 to the linear portions 112 to 114. For example, grinding can be easily performed by use of a common routine with a predetermined amount of cut in a program that operates a grinding machine.

The above cross-sectional shape may be formed in a similar figure along all or part of the working portion 100a in the longitudinal direction. However, a varying shape may be formed as illustrated in FIGS. 5 and 6. In other words, the angles A11 and A12 that the diameter passing through the connection point 121 between the arc-shaped portion 111 and the first linear portion 112 forms with the first linear portion 112 are set in such a manner as to increase from the proximal end portion toward the distal end portion of the working portion 100a. Moreover, the angles A21 and A22 that the diameter passing through the connection point 122 between the first linear portion 112 and the second linear portion 113 forms with the second linear portion 113 are set in such a manner as to increase from the proximal end portion toward the distal end portion of the working portion 100a. It may be set in such a manner that only one of the above changes in the angles A11 and A12 and the angles A21 and A22 occur.

In this manner, the dental file 100 is set in such a manner to have a cross-sectional shape that changes along the longitudinal direction. Consequently, it is possible to set a relatively large cutting force near the proximal end portion while reducing the cutting force to a relatively small force near the distal end portion. Hence, it can facilitate increasing the cutting force toward the proximal end portion while securing flexibility near the distal end portion and high ability to follow the shape of a curved root canal also if the dental file 100 is used at early and finishing stages of root canal preparation and in cases where the cutting force is required along the entire length. Moreover, especially the angles A11 and A12 that the diameter passing through the connection point 121 forms with the first linear portion 112 are set in such a manner as to decrease from the distal end portion toward the proximal end portion. Consequently, the proportion of what is called a pocket to the virtual circle 101 increases, which can facilitate removing debris from the distal end portion to the proximal end portion. The ratio of the cross-sectional area (the second moment of area) to the cross-sectional shape of the virtual circle 101 decreases, which can facilitate further improving flexibility.

### (Other Matters)

In the above cross-sectional shape of the dental file 100, the distances from the center O of the virtual circle 101 to two or more of the first to third linear portions 112 to 114 may be set equal to each other. Alternatively, the linear portions 112 to 114 may be designed to touch the same inscribed circle having the same center as the center O of the virtual circle 101. Such a shape can be easily formed by equalizing the amounts of cut from the circumference of the virtual circle 101 to the linear portions 112 to 114. For example, grinding can be easily performed by use of a common routine with a predetermined amount of cut in a program that operates a grinding machine.

### LIST OF REFERENCE SIGNS

100 Dental file
100a Working portion
100b Shaft
101 Virtual circle
102 Inscribed circle
103 Chord
111 Arc-shaped portion
112 First linear portion
113 Second linear portion
114 Third linear portion
121 Connection point
122 Connection point
123 Connection point

1. A dental file comprising a working portion formed in a helix shape, wherein
a shape of a cross section perpendicular to a longitudinal direction includes one arc-shaped portion, and three first to third linear portions that are continuous sequentially from the arc-shaped portion,
a diameter of a virtual circle including the arc-shaped portion is set in such a manner as to decrease from a proximal end portion toward a distal end portion,
a connection point between the first and second linear portions, and a connection point between the second and third linear portions are set in such a manner as to be located inside the virtual circle, and
an angle that a diameter passing through a connection point between the arc-shaped portion and the first linear portion forms with the first linear portion is set in such a manner as to increase from the proximal end portion toward the distal end portion.

2. The dental file according to claim 1, wherein the ratio of a distance between a center of the virtual circle and the first linear portion to the diameter of the virtual circle is set in such a manner as to increase from the proximal end portion toward the distal end portion.

3. The dental file according to claim 2, wherein the first and third linear portions are formed parallel, and the ratio of a distance between the first and third linear portions to the diameter of the virtual circle is set in such a manner as to increase from the proximal end portion toward the distal end portion.

4. The dental file according to claim 2, wherein an angle subtended on the arc-shaped portion side that a perpendicular from the center of the virtual circle to the first linear portion forms with a perpendicular from the center of the virtual circle to the third linear portion is set in such a manner as to decrease from the proximal end portion toward the distal end portion.

5. The dental file according to claim 1, wherein a central angle of the arc-shaped portion is set in such a manner as to increase from the proximal end portion toward the distal end portion.

6. The dental file according to claim 1, wherein the distances from the center of the virtual circle to the first to third linear portions are set equal to each other.

7. A dental file comprising a working portion formed in a helix shape, wherein
a shape of a cross section perpendicular to a longitudinal direction includes one arc-shaped portion, and three first to third linear portions that are continuous sequentially from the arc-shaped portion,
a diameter of a virtual circle including the arc-shaped portion is set in such a manner as to decrease from a proximal end portion toward a distal end portion,
a connection point between the first and second linear portions is set in such a manner as to be located on the virtual circle, and
a connection point between the second and third linear portions is set in such a manner as to be located inside the virtual circle.

8. The dental file according to claim 7, wherein the first and third linear portions are formed in such a manner as to be perpendicular to a chord of the arc-shaped portion.

9. The dental file according to claim 8, wherein an angle that a diameter passing through a connection point between the arc-shaped portion and the first linear portion forms with the first linear portion, and an angle that a diameter passing through the connection point between the first and second linear portions forms with the second linear portion are set equal to each other.

10. The dental file according to claim 8, wherein the distances from the center of the virtual circle to the first to third linear portions are set equal to each other.

11. The dental file according to claim 7, wherein a connection point between the arc-shaped portion and the first linear portion is located upstream of the connection point between the first and second linear portions in a main rotation direction of the dental file.

12. The dental file according to claim 7, wherein at least one of an angle that a diameter passing through a connection point between the arc-shaped portion and the first linear portion forms with the first linear portion, and an angle that a diameter passing through the connection point between the first and second linear portions forms with the second linear portion is set in such a manner as to increase from the proximal end portion toward the distal end portion.
